(19) United States
(12) Patent Application Publication
(10) Pub. No.: US 2023/0351987 A1
(43) Pub. Date: Nov. 2, 2023

(54) METHOD AND ELECTRONIC DEVICE FOR MATCHING MUSICAL IMAGINARY ELECTROENCEPHALOGRAM WITH MUSICAL PITCH VALUES

(71) Applicant: IUCF-HYU (INDUSTRY-UNIVERSITY COOPERATION FOUNDATION HANYANG UNIVERSITY), Seoul (KR)

(72) Inventors: Eunju JEONG, Seoul (KR); Minjung JI, Seoul (KR); Shinhee PARK, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 18/194,690

(22) Filed: Apr. 3, 2023

(30) Foreign Application Priority Data
Apr. 1, 2022 (KR) 10-2022-0041353

(51) Int. Cl. G10H 1/00

(52) U.S. Cl. CPC G10H 1/0008; G10H 2210/066; G10H 2210/081; G10H 2210/125; G10H 2210/331; G10H 2220/376

(57) ABSTRACT

A method, performed by an electronic device, of matching a musical imaginary electroencephalogram (EEG) with a melody includes obtaining an EEG generated by imagining music from a user, obtaining at least one brain wave segment from the EEG, identifying key points included in the at least one brain wave segment, matching a pitch value to each of the at least one brain wave segment based on the identified key points, and compensating for the pitch value matching the at least one brain wave segment based on a musical probability map.

### CROSS-REFERENCE TO RELATED APPLICATION

This application is based on and claims priority under 35 U.S.C. §119 to Korean Patent Application No. 10-2022-0041353, filed on Apr. 1, 2022, in the Korean Intellectual Property Office, the disclosure of which is incorporated by reference herein in its entirety.

### BACKGROUND

### 1. Field

The disclosure relates to a method and an electronic device for matching an electroencephalogram generated when music is imagined with a melody based on key point analysis and musical progress probability.

### 2. Description of the Related Art

Brain waves or electroencephalogram (EEG) is an electrical signal that is expressed when information is transmitted between the nervous system and cranial nerves of the human body. Brain waves obtainable through a non-invasive method are measurable through electrodes attached to the scalp without a separate surgical operation, and allows real-time activity of the brain to be tracked.

Non-invasive brain-machine interface is an interface technology that recognizes the intention of users through brain waves measured on the scalp and controls external machine and has commonly been used in the medical field for instrument control and communication for disabled or paralyzed patients.

However, due to the recent development of brain wave analysis technology, non-invasive brain-machine interfaces have been applied in various fields including the development of daily life assistance services for ordinary people.

In particular, a brain-computer interface based on music imagination is capable of intuitively recognizing what a user wants to imagine and create music without a separate external stimulus, and thus, its utilization is high.

Such a music imagination activates the left lower frontal cortex, left temporal cortex, premotor cortex area, and supplementary motor area of the brain, which makes it possible to grasp the intention of users according to the music imagination.

For example, music intended by user is recognized using brain waves generated from imagining lyrics, humming, and listening to music.

On the other hand, music information retrieval (MIR) is a technology for extracting various information of music such as genre, rhythm, tempo, and cord by using only a music file without any other information.

Recently, creators of various genres are in the limelight, and in the field of music, people are interested not only in enjoying already created music, but also in creating new music directly. On the other hand, it is not easy to perform a music composing program or an instrument unless one has knowledge or skills in the corresponding program or instrument. Therefore, there is a need for a technology capable of assisting nonprofessionals to easily create music.

On the other hand, as a prior art related to the disclosure, Korean Patent Publication No. 10-2021-0034459 (entitled with: brain waves based music retrieval method and intuitive brain-computer interface device therefor) has been disclosed.

### SUMMARY

The disclosure provides an electronic device and method capable of matching musical imaginary electroencephalogram (EEG) obtained from a user to a melody closer to imaginary intention of the user, by matching brain wave segments and pitch values based on a musical probability map considering harmony or at least one preceding pitch value as well as a pitch value classification probability according to key points of brain wave segments.

The disclosure also provides an electronic device and method capable of converting EEG by music imagination into a more natural melody and assisting nonprofessionals in music creation through music imagination, by compensating for pitch values classified based on key points of brain wave segments based on a musical probability map representing the probability of appearance of following pitch values according to harmonic or melodic progression.

A technical problem to be achieved by an embodiment of the disclosure is not limited to the technical problem as described above, and other technical problems may be inferred from the following embodiments.

Additional aspects will be set forth in part in the description which follows and, in part, will be apparent from the description, or may be learned by practice of the presented embodiments of the disclosure.

According to an embodiment, a method, performed by an electronic device, of matching a musical imaginary electroencephalogram (EEG) with a melody includes obtaining an EEG generated by imagining music from a user, obtaining at least one brain wave segment from the EEG, identifying key points included in the at least one brain wave segment, matching a pitch value to each of the at least one brain wave segment based on the identified key points, and compensating for the pitch value matching the at least one brain wave segment based on a musical probability map.

The obtaining of the EEG generated by imagining music from the user may include a preprocessing operation of removing noise unrelated to music imagination from the EEG obtained from the user.

The obtaining of the at least one brain wave segment from the EEG may include dividing the EEG into at least one brain wave segment based on a preset rhythm.

The identifying of the key points included in the at least one brain wave segment may include identifying the key points included in the at least one brain wave segment based on an F value of the at least one brain nave segment.

The matching of the pitch value to each of the at least one brain wave segment based on the identified key points may include matching the pitch value to each of the at least one brain wave segment based on a statistical probability map determined according to a correspondence between a key point set included in a specific brain wave segment and the pitch value.

The compensating for of the pitch value matching the at least one brain wave segment based on the musical probability map may include determining a pitch value corresponding to the at least one brain wave segment according to the statistical probability map and the musical probability map through a Bayesian model.

The statistical probability map may be trained based on an EEG obtained as a user is provided with part of preset music and imagines part of the music following the provided part of the music.

The musical probability map may be determined based on a melodic progression of a plurality of pieces of preset music.

The musical probability map may include probability information of occurrence of a following pitch value with respect to two preceding pitch value sets or probability information of occurrence of a following pitch value with respect to four preceding pitch value sets.

The musical probability map may be determined based on a harmonic progression of a plurality of pieces of preset music.

The method may be identified in a plurality of modes according to a degree of compensation for the pitch value matching the at least one brain wave segment based on the musical probability map.

According to another embodiment, an electronic device matching musical imaginary electroencephalogram (EEG) with a melody includes an EEG measurement unit, a storage unit storing one or more instructions, and at least one processor configured to execute the one or more instructions stored in the memory. The processor may execute the one or more instructions, to obtain an EEG generated by a user imagining music through the EEG measurement unit, obtain at least one brain wave segment from the EEG, identify key points included in the at least one brain wave segment, match a pitch value to each of the at least one brain wave segment based on the identified key points, and compensate for the pitch value matching the at least one brain wave segment based on a musical probability map stored in the storage unit.

According to another embodiment, a computer-readable recording medium disclosed may have stored therein a program for executing at least one of some embodiments of the method on a computer.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of a method, performed by an electronic device, of matching a musical imaginary electroencephalogram (EEG) with a melody according to an embodiment;

FIG. 2 is a flowchart schematically illustrating a method, performed by an electronic device, of matching a musical imaginary EEG with a melody according to an embodiment;

FIG. 3 is a flowchart illustrating a method of generating a model matching a musical imaginary EEG with a melody according to an embodiment;

FIG. 4 is a diagram illustrating an operation in which an electronic device provides part of music to a user in order to induce natural music imagination of the user according to an embodiment;

FIGS. 5A and 5B are diagrams illustrating an operation in which an electronic device obtains a musical probability map according to a melodic progression probability according to an embodiment;

FIG. 6 is a diagram illustrating an operation in which an electronic device obtains a musical probability map according to a harmonic progression according to an embodiment; and

FIG. 7 is a block diagram of an electronic device according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments of the disclosure will be described in detail with reference to the attached drawings to allow those of ordinary skill in the art to easily carry out the embodiments of the disclosure. However, the disclosure may be implemented in various forms, and are not limited to the embodiments of the disclosure described herein. To clearly describe the disclosure, parts that are not associated with the description have been omitted from the drawings, and throughout the specification, identical reference numerals refer to identical parts.

Although terms used in embodiments of the disclosure are selected with general terms popularly used at present under the consideration of functions in the disclosure, the terms may vary according to the intention of those of ordinary skill in the art, judicial precedents, or introduction of new technology. In addition, in a specific case, the applicant voluntarily may select terms, and in this case, the meaning of the terms may be disclosed in a corresponding description part of an embodiment of the disclosure. Thus, the terms used in herein should be defined not by the simple names of the terms but by the meaning of the terms and the contents throughout the disclosure.

It is to be understood that the singular forms include plural references unless the context clearly dictates otherwise. All of the terms used herein including technical or scientific terms have the same meanings as those generally understood by those of ordinary skill in the art of the specification.

Throughout the entirety of the specification of the disclosure, when it is assumed that a certain part includes a certain component, the term ‘including’ means that a corresponding component may further include other components unless specially described to the contrary. The term used herein such as “... unit” or “... module” indicates a unit for processing at least one function or operation, and may be implemented in hardware, software, or in a combination of hardware and software.

Throughout the specification, when any portion is “connected” to another portion, it may include not only a case where they are “directly connected”, but also a case where they are “electrically connected” with another element therebetween.

Expression used in the present specification “... configured to” may be exchangeably used with, for example, “...suitable for”, “...having the capacity to”..designed to”, “... adapted to”, “... made to”, or “... capable of”, depending on a situation. The term “... configured to” may not necessarily mean “... specially designed to” in terms of hardware. Instead, in a certain situation, the expression “a system configured to...” may mean that the system is “capable of..” together with other devices or parts. For example, the phrase “a processor configured (or set) to perform A, B, and C” may mean a dedicated processor (e.g., an embedded processor) for performing a corresponding operation or a general-purpose processor (e.g., a central processing unit (CPU) or an application processor) capable of performing corresponding operations by executing one or more software programs stored in a memory.

A function related to artificial intelligence (AI) according to the disclosure may be performed by a processor and a memory. The processor may include one processor or a plurality of processors. At this time, one processor or a plurality of processors may include a general-purpose processor, such as a CPU, an application processor (AP), a digital signal processor (DSP), etc., a graphic-dedicated processor, such as a GPU, a vision processing unit (VPU), etc., or an Al-dedicated processor, such as a neural processing unit (NPU). One processor or a plurality of processors may process input data according to a predefined operation rule or an AI model stored in the memory. When the one processor or a plurality of processors includes an Al-dedicated processor, the AIdedicated processor may be designed to have a hardware structure specialized for processing a specific AI model.

The predefined operation rule or the AI model may be made through training. Herein, when the AI model is made through training, it may mean that a basic AI model (or a deep learning model) is trained based on a learning algorithm by using multiple training datasets, such that the predefined operation rule or AI model set to execute desired characteristics (or purpose) is made. Such learning may be performed by a device on which AI according to the disclosure is implemented, or by a separate server and/or system. Examples of a learning algorithm may include, but not limited to, supervised learning, unsupervised learning, semi-supervised learning, or reinforcement learning.

The AI model (or a deep learning model) may include a plurality of neural network layers. Each of the plurality of neural network layers may have a plurality of weight values, and perform a neural network operation through an operation between an operation result of a previous layer and the plurality of weight values. The plurality of weight values of the plurality of neural network layers may be optimized by a training result of the AI model. For example, the plurality of weight values may be updated to reduce or minimize a loss value or a cost value obtained in the AI model during a training process. Examples of the AI neural network may include, but not limited to, a deep neural network (DNN), a convolutional neural network (CNN), a recurrent neural network (RNN), a restricted Boltzmann machine (RBM), a deep belief network (DBN), a bidirectional recurrent deep neural network (BRDNN), and a deep Q-network.

In the disclosure, ‘brane wave’ or ‘electroencephalogram (EEG)’ represents the flow of electricity generated when a signal is transmitted between cranial nerves in the human nervous system. EEG may refer to a technology of recording brain waves by attaching electrodes to the cortex, or may refer to a graphical representation of brain waves recorded by such a technology. Brane wave may have a waveform shape that vibrates in a complex pattern. A power spectrum analysis technique that classifies components of the brane wave according to frequency may be used to analyze the brane wave. The power spectrum analysis technique may be performed by assuming that brane wave is a linear combination of vibrations having a specific frequency, decomposing each frequency component, and calculating a magnitude thereof. Brane wave generated from the huma brain may have a frequency of about 0 to about 30 Hz and an amplitude of about 20 µV to about 200 µV. A brane wave segment may represent at least a part of EEG.

EEG in which brain waves are recorded may have a key point for each section of the graph. The key point may represent a key part in the EEG. For example, key points may be determined according to wave graph characteristics such as waveform, amplitude, frequency, etc. In an embodiment, key point sets included in each brain wave segment may be compared when determining whether a specific brain wave segment and another brain wave segment match each other.

In the disclosure, ‘melody’ or ‘tune’ represents a set of notes arranged in a horizontal or temporal order in music. A ‘scale’ may represent a set of notes arranged in order of the height of note.

In the disclosure, ‘harmony’ represents the temporal flow of sound generated by the succession of chords in music. A chord may represent a vertical set of a plurality of tones having different pitches.

In the disclosure, ‘frequency or pitch’ represents the height of note. The frequency may be represented in units of Hz indicating how many times the waveform vibrates in one second. The higher the number of vibrations per second, the higher the frequency, and when the number of vibrations doubles, a note having one octave higher is generated. The frequency may indicate an absolute height of note, and the pitch may indicate a relative pitch of note. For example, the frequency may express which octave of 12 scales a specific note belongs to, and the pitch may express the relative height of the note according to the harmony through numbering.

Hereinafter, a method of matching a musical imaginary electroencephalogram (EEG) with a melody according to an embodiment and an electronic device therefor are described in detail with reference to the accompanying drawings.

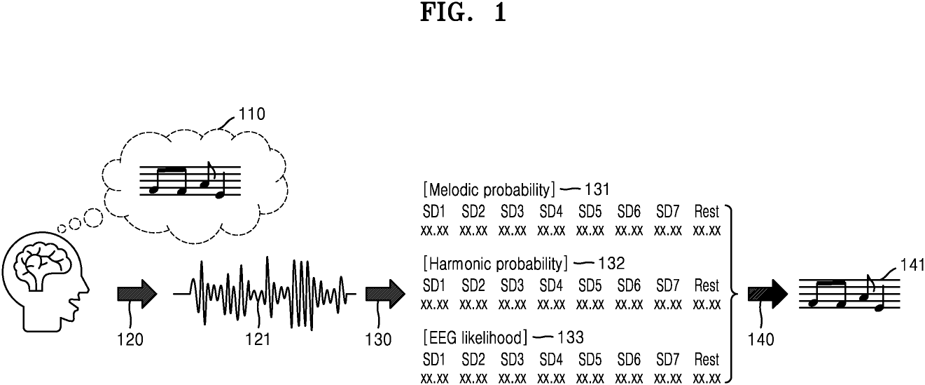

FIG. 1 is a schematic diagram of a method, performed by an electronic device, of matching a musical imaginary EEG 121 with a melody 141 according to an embodiment.

The method of matching the musical imaginary EEG 121 with the melody 141 according to an embodiment may intuitively infer a music 110 imagined by a user and output the music 110 as a melody 141 based on the EEG 121 generated by the user imagining music. For example, the EEG 121 generated when the user imagines music may be mapped to the scale (melody) 141 that is estimated to be imagined by the user.

When people remember songs or melodies they have heard before, or create new music, it may be difficult to describe the music they are imagining in notes or words. In order to solve this problem, the frequency or pitch of the music 110 imagined by the user may be distinguished using an EEG analysis technology and a brain-computer interface (BCI) technology.

In an embodiment, the electronic device may record the EEG 121 generated during imagining music, and then, extract the melody 141 of the imagined music 110 from the EEG 121 measured by identifying key points of the EEG using signal processing and statistical methodology, and combining a probability 133 that the identified key point set corresponds to a specific pitch value and a musical probability map (a melodic probability 131 and a harmonic probability 132) considering at least one preceding scale.

In operation 110, the user may imagine the music 110. The music 110 imagined by the user may be known music or newly created music by the user.

In operation 120, the electronic device may obtain the EEG 121 generated by imagining music from the user. The EEG 121 obtained from the user may correspond to the imagined music 110. In an embodiment, the operation in which the electronic device obtains the EEG 121 generated from the user by imagining music may include a preprocessing operation of removing noise unrelated to the imagining of music from the EEG 121 obtained from the user. For example, the electronic device may perform the preprocessing operation by filtering a signal of the obtained EEG 121 by applying a band pass filter, and then removing noise caused by the user’s movement and eye blinking. In an embodiment, the band pass filter used for a filtering operation may filter the signal of the EEG 121 in the range of about 0.5 Hz to about 50 Hz.

The electronic device may obtain at least one brain wave segment from the obtained EEG 121. The brain wave segment may represent at least a part of the EEG 121 corresponding to the imagined music 110. In an embodiment, the brain wave segment may represent a partial section of an EEG graph plotted on a time axis. For example, the brain wave segment may represent an EEG graph over a specific consecutive time interval. The brain wave segment may be a time-sequential segment of the signal of the EEG 121 for each note. In an embodiment, the operation in which the electronic device obtains at least one brain wave segment from the EEG 121 may include an operation of separating the EEG 121 into at least one brain wave segment based on a preset rhythm. The electronic device may convert the brain wave segment which is a time-sequential signal into time-frequency domain data.

The EEG 121 in which brain waves are recorded may have key points for each section of the graph. The key point may indicate a key part in the graph of the EEG 121. For example, the key point may be determined according to wave graph characteristics such as waveform, amplitude, frequency, etc. The electronic device may identify key points included in the obtained brain wave segment. In an embodiment, an operation in which the electronic device identifies key points included in the brain wave segment may include an operation of identifying key points included in the brain wave segment based on an F value of the brain wave segment. For example, the electronic device may select data corresponding to a frequency or a time band having a higher F value as key data among brain wave segment data corresponding to the pre-frontal lobe, the frontal lobe, the temporal lobe, or the intraparietal sulcus.

F-value (F-atio or F-statistic) is a value of a continuous probability distribution used in a F-distribution (Snedecor’s F-distribution, or Fisher-Snedecor distribution) and may be expressed as a ratio distribution or a quotient distribution. The F value may be used as an index for comparing several samples. A variance Var is the arithmetic mean of values obtained by squaring a deviation which is a difference between the statistical value and the mean value. A small variance may indicate that samples are clustered around the mean value, and a large variance may indicate that many samples are far from the mean value. The F value may be expressed as a value obtained by dividing the average variance between samples by the variance within the sample.

In operation 130, the electronic device may match a pitch value to each brain wave segment based on the identified key points. In an embodiment, the electronic device may match the pitch value to each brain wave segment based on the statistical probability map. The statistical probability map may include information about a key point set corresponding to a specific pitch value. For example, the statistical probability map may include information about the probability 133 that a specific key point set corresponds to a specific pitch value. When matching the pitch value to the brain wave segment based on the statistical probability map, the electronic device may match the pitch value to the brain wave segment based on the probability 133 that the identified key point set corresponds to a specific pitch value.

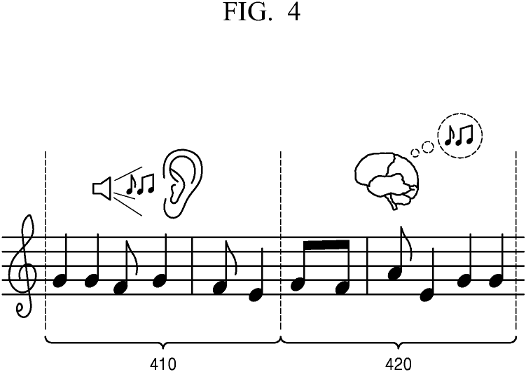

A statistical probability map including information about which brain wave having a key point is generated when a specific note is imagined may be generated by measuring an EEG generated when a user imagines the specific note. For example, a correspondence relationship between a brain wave segment or a key point set and a pitch value may be obtained by inducing a user to imagine music and measuring an EEG generated when the user imagines music. In an embodiment, the statistical probability map may be trained based on an EEG obtained as a user is provided with preset part of music and imagines part of music immediately following the provided part of music. After part of music known to a user is played to the user, when the user is induced to imagine a later part following the corresponding part, the user may naturally imagine a more accurate note. The statistical probability map trained as described above may include more accurate matching probability information between the key point set and the pitch value. The statistical probability map according to an embodiment will be described in more detail with reference to FIG. 4 below.

In an embodiment, the operation in which the electronic device allows the key point set identified from the brain wave segment to correspond to the specific pitch value may use an artificial intelligence model trained to output a pitch value including octave information and note information by using the identified key point set as an input value.

In an embodiment, the electronic device may compensate for the pitch value matching the brain wave segment based on a musical probability map. The musical probability map may include information related to the melodic probability 131 in which a specific pitch value is generated as a following note when considering at least one preceding scale and the harmonic probability 132.

In an embodiment, the musical probability map may be determined based on a preset melodic progression of a plurality of pieces of preset music. For example, the melodic probability 131 may be determined based on a frequency at which a specific pitch value is generated following a preceding scale in a plurality of pieces of previously known music. In an embodiment, the musical probability map may be determined based on a preset harmonic progression of a plurality of pieces of music. For example, the harmonic probability 132 may be determined based on the frequency at which the specific pitch value is generated based on harmonies, chords, and tones of a plurality of pieces of previously known music.

In an embodiment, the musical probability map may include probability information of occurrence of a following pitch value with respect to two preceding pitch value sets or probability information of occurrence of a following pitch value with respect to four preceding pitch value sets. Meanwhile, the number of preceding notes considered in the musical probability map is not limited to two or four, and any number of preceding notes may be considered.

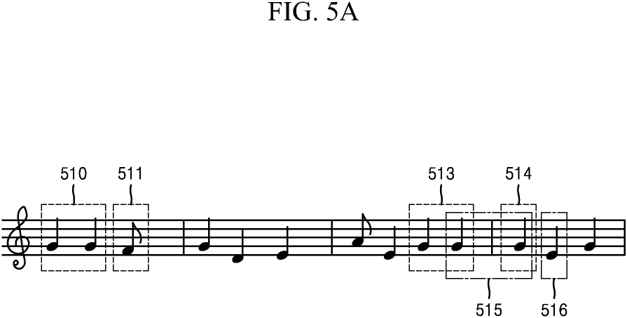

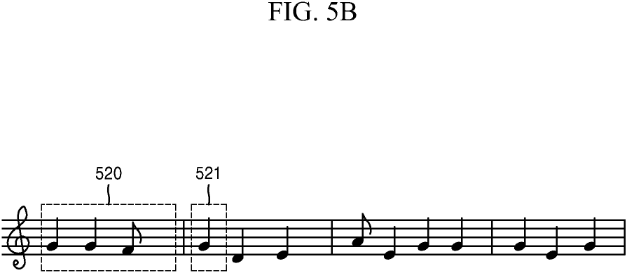

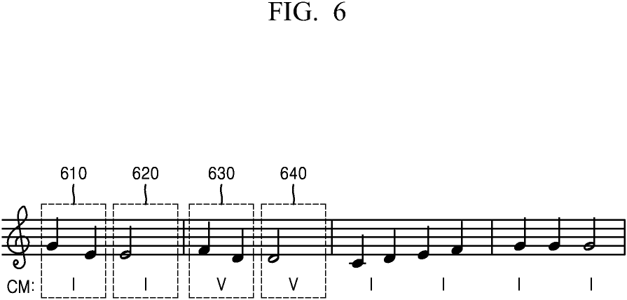

The musical probability map considering the melodic probability 131 of at least one preceding scale according to an embodiment is described in more detail with reference to FIG. 5 below, and the musical probability map considering the harmonic probability 132 of at least one preceding scale is described in more detail with reference to FIG. 6 below.

When compensating for the pitch value matching the brain wave segment based on the musical probability maps 131 and 132, the electronic device may more musically compensate for the melody 141 obtained by matching the pitch value to each brain wave segment constituting the EEG 121.

For example, based on key points identified in a specific brain wave segment, when a probability that the corresponding brain wave segment corresponds to ‘2 octave Do C4’ is about 40 % and the probability that the corresponding brain wave segment corresponds to ‘2 octave Re D4’ is about 60 %, the pitch value matching the corresponding brain wave segment according to the statistical probability map 133 may be D4. On the other hand, considering the preceding scale matching at least one preceding brain wave segment rather than the corresponding brain wave segment, the melodic probability or harmonic probability that the corresponding brain wave segment corresponds to C4 may be 90 %, and the melodic probability or harmonic probability that the corresponding brain wave segment corresponds to D4 may be 10 %. That is, with respect to the key point extracted from the brain wave segment, even if note D4 is close to what the user imagined, in terms of music, when the corresponding note is C4, a more natural melody may be configured. In this case, the electronic device may compensate for the pitch value matching the brain wave segment based on the musical probability maps 131 and 132, and finally determine the pitch value matching the corresponding brain wave segment as C4.

In an embodiment, the Bayesian model may be used for the operation in which the electronic device compensates for the pitch value matching the specific brain wave segment based on the musical probability map. The Bayesian model is based on the Bayesian theory indicating the relationship between the prior and posterior probabilities of two random variables. For example, when a pitch value matching a specific brain wave segment is determined based on a statistical probability and a musical probability (a melodic probability or a harmonic probability), Equation 1 below may be used.

$$P \left(A \left|B\right)\right) = \frac{P \left(B \left|A\right)\right) P \left(A\right)}{P \left(B \left|A\right)\right) P \left(A\right) + P \left(B \left|{A}^{′}\right)\right) P \left({A}^{′}\right)} \qquad \text{[Equation 1]}$$

Here, P(A|B) represents a probability that a note that the user imagined to generate the specific brain wave has a first pitch value when the corresponding brain wave segment is obtained. P(B|A) represents a probability that a brain wave segment having a specific key point is obtained when the user imagines the note having the first pitch value. P(A) represents a probability that the note having the first pitch value is imagined according to the musical probability (the melodic probability or the harmonic probability). P(B|A′) represents a probability that the brain wave segment having the specific key point is obtained when the user imagines a note having a value other than the first pitch value. P(A′) represents a probability that the note having the value other than the first pitch value is imagined according to the musical probability (the melodic probability or the harmonic probability).

As described above, according to an embodiment, the EEG 121 generated by a music imagining operation may match the melody 141 closer to the intention of the user, by matching a brain wave segment with a final pitch value based on a musical probability considering at least one preceding scale as well as a statistical pitch value classification probability based on key points of the brain wave segment.

According to the method of matching the musical imaginary EEG 121 with the melody and the electronic device therefor proposed in the disclosure, the music imagined by the user based on the brain wave may be directly expressed as a score 141. The electronic device may include an intuitive brain-computer interface device. In an embodiment, a method of obtaining the EEG 121 generated in a music imagination process 110 intuitively inferring the melody of music imagined by the user, and outputting the melody as a scale may be provided. That is, based on the EEG 121 obtained according to the music imagining of the user, music that the user wants to create or reproduce may be intuitively inferred and output as the scale 141. In addition, the music imagined by the user may be output in the form of sound or score, thereby providing a neural entertainment brain-computer interface system that may be used in various fields with a high degree of freedom.

In addition, according to the method of matching the musical imaginary EEG 121 with the melody and the electronic device therefor proposed in the disclosure, pitch values classified based on key points of brain wave segments may be compensated for based on the musical probability maps 131 and 132 representing the probability of appearance of a specific pitch value according to the melodic progression and harmony, thereby converting the EEG 121 generated from the music imagining operation into a more natural and ‘musical’ melody, and assisting a non-professional in music creation through music imagination. That is, a technology for audibly or visually implementing EEG data may be provided.

Meanwhile, in an embodiment, the operation in which the electronic device matches the musical imaginary EEG 121 with the melody may be identified in a plurality of modes. In the plurality of modes, a compensation degree of the operation for compensating for a pitch value based on a musical probability map may be set differently. For example, the plurality of modes may include a first mode having a relatively strong compensation degree and a second mode having a relatively weak compensation degree.

For example, in the first mode, a higher weight may be set to a musical probability among a statistical probability corresponding to a key point of a brain wave segment and a pitch value and the musical probability (the melodic probability and the harmonic probability) considering progression of a preceding scale or harmony. For example, when a pitch value matching a specific brain wave segment according to the statistical probability and a pitch value matching the specific brain wave segment according to the musical probability are different, the electronic device of the first mode may determine that the pitch value matches the corresponding brain wave segment according to the musical probability. In this case, a more musical melody may be obtained from the musical imaginary EEG, and the first mode may be suitable for the purpose of assisting a non-professional in music creation.

For example, in the second mode, a higher weight may be set to a statistical probability among the statistical probability corresponding to a key point of a brain wave segment and a pitch value and a musical probability (the melodic probability and the harmonic probability) considering progression of a preceding scale or harmony. For example, when a pitch value matching a specific brain wave segment according to the statistical probability and a pitch value matching the specific brain wave segment according to the musical probability are different, the electronic device of the second mode may determine that the pitch value matches the corresponding brain wave segment according to the statistical probability. In this case, a melody of tones different from normal melodic and harmonic progressions may be obtained from the musical imaginary EEG, and the second mode may be suitable for the purpose of assisting challenging music creation and an input interface of a score generating program.

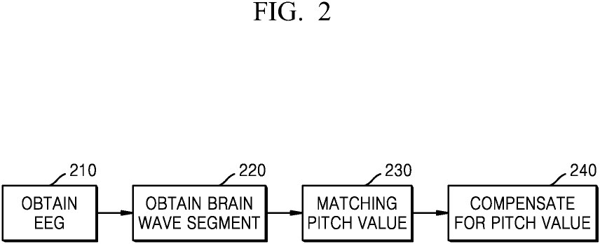

FIG. 2 is a flowchart schematically illustrating a method, performed by an electronic device, of matching a musical imaginary EEG with a melody according to an embodiment.

In operation 210, the electronic device obtains an EEG generated by imagining music from a user. The EEG obtained from the user may be generated by the user imagining music. In an embodiment, the operation in which the electronic device obtains the EEG may further include a preprocessing operation of removing noise unrelated to the imagining of music from the EEG obtained from the user. In an embodiment, operation 210 may correspond to operation 120 of FIG. 1 described above.

In operation 220, the electronic device obtains at least one brain wave segment from the obtained EEG. The brain wave segment may represent at least a part of an EEG corresponding to imagined music. In an embodiment, the brain wave segment may represent a partial section of an EEG graph plotted on a time axis. For example, the brain wave segment may represent an EEG graph over a specific consecutive time interval. In an embodiment, the operation in which the electronic device obtains the brain wave segment from the EEG may include an operation of separating the EEG into at least one brain wave segment based on a preset rhythm.

In operation 230, the electronic device matches a pitch value to the obtained brain wave segment.

In an embodiment, the electronic device may identify at least one key point included in the obtained brain wave segment. A brain wave segment may have at least one key point. The key point may indicate a key part in the graph of the EEG For example, the key point may be determined according to wave graph characteristics such as waveform, amplitude, frequency, etc. At least one key point included in a brain wave segment may constitute a key point set. In an embodiment, an operation in which the electronic device identifies the key point included in the brain wave segment or the key point set corresponding to the brain wave segment may include an operation of identifying key points included in the brain wave segment based on an F value of the brain wave segment.

The electronic device may match a pitch value to each brain wave segment based on the key point set corresponding to the brain wave segment. In an embodiment, the electronic device may match the pitch value to each brain wave segment based on the statistical probability map. The statistical probability map may include information about a key point set corresponding to a specific pitch value. For example, the statistical probability map may include probability information that a specific key point set corresponds to a specific pitch value. When matching the pitch value to the brain wave segment based on the statistical probability map, the electronic device may match the pitch value to the brain wave segment based on a probability that the identified key point set corresponds to a specific pitch value. The statistical probability map according to an embodiment is described in more detail with reference to FIG. 4 below.

In an embodiment, operations 220 and 230 may correspond to operation 130 of FIG. 1 described above.

In operation 240, the electronic device compensates for the pitch value matching the brain wave segment based on a musical probability map. The musical probability map may include melodic probability information that a specific pitch value is generated as a following note when considering at least one preceding scale, and harmonic probability information that a specific pitch value is generated when considering the harmony of music. In an embodiment, the musical probability map may be determined based on a preset melodic progression of a plurality of pieces of music. For example, the melodic probability may be determined based on a frequency at which a specific pitch value is generated following a preceding scale in a plurality of pieces of previously known music. In an embodiment, the musical probability map may be determined based on preset harmonies of a plurality of pieces of music. For example, the harmonic probability may be determined based on the frequency at which the specific pitch value is generated based on harmonies, chords, and tones of a plurality of pieces of previously known music. The musical probability map considering the melodic probability of at least one preceding scale according to an embodiment is described in more detail with reference to FIG. 5 below, and the musical probability map considering the harmonic probability according to the harmony of music is described in more detail with reference to FIG. 6 below.

In an embodiment, the Bayesian model may be used for the operation in which the electronic device compensates for the pitch value matching the specific brain wave segment based on the musical probability map. As described above, according to an embodiment, the EEG generated by a music imagining operation may match the melody closer to the intention of the user, by matching a brain wave segment with a final pitch value based on a musical probability considering at least one preceding scale as well as a statistical pitch value classification probability based on key points of the brain wave segment. In an embodiment, operation 240 may correspond to operation 140 of FIG. 1 described above.

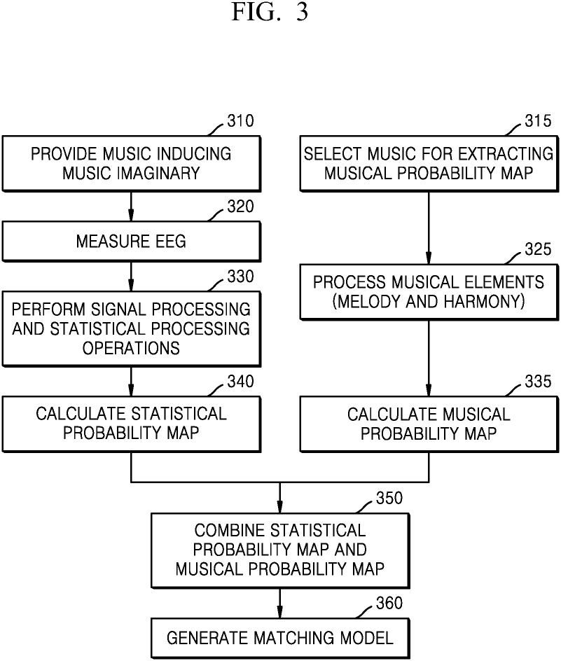

FIG. 3 is a flowchart illustrating a method of generating a model matching a musical imaginary EEG with a melody according to an embodiment.

The model matching the musical imaginary EEG with the melody according to an embodiment is executed by an electronic device, so that the electronic device may intuitively infer music imagined by a user and output the music as the melody.

The finally generated matching model may be generated in operation 360 by combining a statistical probability map and a musical probability map in operation 350. According to an embodiment, the model matching the melody with an EEG generated by music imagination may be obtained based on a matching relationship between brain wave segments and pitch values according to a brain wave key point set, and the musical probability map. The Bayesian model may be used for the operation of combining the statistical probability map and the musical probability map in operation 350.

The statistical probability map includes information about statistical matching probabilities between brain wave segments that are part of the EEG and pitch values, and may be obtained through operations 310 to 340.

In operation 310, inducement music may be provided to induce the user to imagine music. In an embodiment, a specific piece of music known to the user in advance may be provided to the user to induce a natural music imagination of the user. In this case, the user may be induced to imagine a later part immediately following the provided music. When a piece of music known to the user is played, the user may easily imagine a following later part. That is, the user may naturally imagine a more accurate note. Therefore, in this case, natural music imagination may be induced, and the EEG of the user obtained as described above may be considered to match a melody of the corresponding part at high accuracy. That is, as more natural imagination is induced, the stability of measured data (e.g., matching relationship between brain wave segments and pitch values) may be secured.

In operation 320, the EEG generated by the user imagining music may be measured. The EEG may be divided into at least one brain wave segment. The brain wave segment may represent a partial section of an EEG graph plotted on a time axis. For example, the brain wave segment may represent an EEG graph over a specific consecutive time interval. In an embodiment, the EEG may be divided into brain wave segments based on a preset rhythm.

In an embodiment, an EEG for generating a model may be obtained globally from various users. In this case, the generated model may be applied to various users. In an embodiment, a specific model may be applied only to a specific user. That is, models may be individualized for each user. In this case, an EEG for generating an individualized model may be obtained only from the corresponding user, or may have different weights set for each user when obtained from various users.

In an embodiment, for accuracy of measurement of the EEG data generated by the user imagining music, an operation of confirming what the imagined melody is to the user may be further performed after obtaining the EEG. In the operation of confirming the imagined melody, the EEG and the imagined melody may correspond to each other by having the user hum a melody imagined in a music imagining operation.

In operation 330, signal processing and statistical processing operations may be performed on the measured EEG.

A signal processing operation on the measured EEG may include a preprocessing operation of removing noise unrelated to the imagining of music from the EEG. In an embodiment, the preprocessing operation may include an operation of identifying a region of interest (ROI) in the measured EEG data. The ROI may include a plurality of brain wave segments. In addition, in the preprocessing operation, a region related to the music imagining operation may be determined in the EEG graph.

The key point may represent a key part in the EEG. For example, key points may be determined according to wave graph characteristics of the EEG such as waveform, amplitude, frequency, etc. In a signal processing operation, key points may be extracted from the EEG, and the key points included in the EEG may be grouped according to brain wave segments. For example, a key point set corresponding to one brain wave segment may be identified. In an embodiment, the key point set may be identified based on an F value of a brain wave segment. In an embodiment, a key point may be extracted with respect to only the ROI determined through the signal processing operation. In this case, an operational load may be reduced, and efficient operation of operational resources may be possible in the model generation operation.

For example, the EEG graph may be converted into a frequency-time domain and then grouped into brain wave segments. In this case, a specific pitch value may match each grouped brain wave segment. F values of the entire frequency and time data may be calculated from grouped brain wave segment data. Data corresponding to a frequency or time band having an upper F value among data within the identified brain wave segment may be determined as key data (key points) of the corresponding brain wave segment.

A statistical processing operation may be performed on the EEG on which the signal processing operation has been performed. The statistical processing operation may include an operation of calculating a correspondence relationship between brain wave segments and pitch values based on the key point set.

In operation 340, a statistical probability map may be calculated by calculating a statistical matching probability between the EEG and the phonogram values. The statistical probability map may include information about a key point set corresponding to a specific pitch value. For example, the statistical probability map may include information about a probability that a specific key point set corresponds to a specific pitch value, that is, information about which brain wave having a key point is generated when a specific note is imagined.

The statistical probability map used for generating the matching model according to an embodiment may be generated by letting the user hear part of music known to the user and then inducing the user to naturally imagine the later part following the corresponding part as in operation 310, and the statistical probability map calculated as described above may include more accurate matching probability information between the key point set and the pitch value.

The musical probability map includes information related to a melodic probability and a harmonic probability that a specific pitch value is generated as a following note when considering the harmony of music or at least one preceding scale, and may be obtained through operations 315 to 335.

In operation 315, a plurality of pieces of previously known music to be used in calculating the musical probability map may be selected. The plurality of pieces of previously known music may be selected based on rhythm, beat, musical genre, etc. For example, among a plurality of pieces of existing music, music in which at least some of musical conditions are the same may be selected, and through subsequent operations, the probability of following melodic progression according to melodic progression and the probability of occurrence of a specific pitch value according to harmony may be calculated with respect to the selected pieces of music.

In operation 325, musical elements, for example, melodic progression information or harmony information, may be analyzed with respect to the selected pieces of music. Tune or melody represents a set of notes arranged in a horizontal or temporal order in music, and harmony represents the temporal flow of sound generated by the succession of chords in music. A pitch value pattern generally used in music may be known by analyzing the melodic progression information and harmony information of the selected pieces of music.

In operation 335, a musical probability map may be calculated based on the musical elements of the plurality of pieces of previously known music. The musical probability map may include information related to a melodic probability that a specific pitch value is generated as a following note when considering at least one preceding scale, and information related to a harmonic probability that a specific pitch value is generated when considering harmony.

In an embodiment, the musical probability map may include probability information that a note having a specific pitch value appears as a following note according to a general melodic progression or harmonic progression trend of the pieces of previously known music. For example, the probability of occurrence of a following note according to a melodic progression (probability that a note having a specific pitch value with respect to at least one preceding note appears as a following note) and the probability of occurrence of a following note according to a harmonic progression (probability that a specific note appears in a specific harmony) may be calculated.

In an embodiment, the musical probability map may be determined based on the melodic progression of a plurality of pieces of previously known music. For example, the melodic probability may be determined based on a frequency at which a specific pitch value is generated following a preceding scale in a plurality of pieces of previously known music.

For example, the musical probability map may include information about a transition probability of a pitch value in various pieces of previously known music. Using the transition probability information, a pitch value of a next note to appear in each note may be determined. The transition probability of the pitch value may indicate a probability of a melody progressing from a current note to a next note. For example, as a result of analyzing several pieces of previously known music, when a note having a pitch value of ‘Do (C)’ appears 10 times, and when ‘Mi’ (E) appears 3 times and ‘Sol (G)’ appears 7 times as a note after the note of ‘Do C’, the transition probability of a pitch value from ‘Do (C)’ to ‘Mi (E)’ may be 0.3, and the transition probability of a pitch value from ‘Do (C)’ to ‘Sol (G) may be 0.7. In an embodiment, the musical probability map may include transition probability information from two or more preceding note sequences to the next pitch value.

In an embodiment, the musical probability map may include probability information of occurrence of a following pitch value with respect to two preceding pitch value sets or probability information of occurrence of a following pitch value with respect to four preceding pitch value sets. Meanwhile, the number of preceding notes considered in the musical probability map is not limited to two or four, and any number of preceding notes may be considered.

In an embodiment, the musical probability map may be determined based on the harmonic progression of a plurality of pieces of previously known music For example, the harmonic probability may be determined based on the frequency at which the specific pitch value is generated based on harmonies, chords, and tones of a plurality of pieces of previously known music.

The musical probability map considering the melodic probability of at least one preceding scale according to an embodiment is described in more detail with reference to FIG. 5 below, and the musical probability map considering the harmonic probability is described in more detail with reference to FIG. 6 below.

Referring back to operation 350, the matching model may be generated by combining the statistical probability map and the musical probability map according to preset weights. The matching model generated according to an embodiment may have various modes. For example, the matching model may include a first mode in which the weight of the musical probability map is relatively higher than that of the statistical probability map, and a second mode in which the weight of the musical probability map is relatively lower than that of the statistical probability map.

In the first mode, when a pitch value matching a specific brain wave segment according to the statistical probability and a pitch value matching a specific brain wave segment according to the musical probability are different, the pitch value may be determined to match the corresponding brain wave segment according to the musical probability. In this case, a more musical melody may match the musical imaginary EEG, and a matching model of the first mode may be suitable for the purpose of assisting a non-professional in music creation. That is, when using the matching model of the first mode, even if the EEG does not exactly match an EEG corresponding to a pitch value, matching of pitch values may be performed to match the normal flow of music. In this case, a more natural melody may match the EEG, and may also further match the intention of the user.

In the second mode, when a pitch value matching a specific brain wave segment according to the statistical probability and a pitch value matching a specific brain wave segment according to the musical probability are different, the pitch value may be determined to match the corresponding brain wave segment according to the statistical probability. In this case, a melody of tones different from normal melodic and harmonic progressions may match the musical imaginary EEG, and a matching model of the second mode may be suitable for the purpose of assisting challenging music creation and an input interface of a score generating program. That is, when using the matching model of the second mode, matching that violates the normal melodic flow may be performed.

As described above, according to an embodiment, a matching model capable of matching the EEG generated by a music imagining operation with the melody closer to the intention of the user may be generated, by matching a brain wave segment with a final pitch value based on a musical probability considering at least one preceding scale as well as a statistical pitch value classification probability based on key points of the brain wave segment.

That is, according to an embodiment, the matching accuracy of the matching model matching the EEG to the melody may be increased, and the EEG by music imagination may be decoded with a more musical melody, by combining the probability of musical progression with the correspondence probability with respect to the pitch value of a brain wave segment.

FIG. 4 is a diagram illustrating an operation in which an electronic device provides part of music to a user in order to induce natural music imagination of the user according to an embodiment.

For example, previously known music may include a first section 410 and a second section 420 that are continuous. In order to induce natural music imagination of the user, the previously known music may be music known to the user.

In an embodiment, the electronic device may audibly provide the first section 410 to the user to induce the user to imagine the second section 420 immediately following the first section 410. When part of music known to the user is provided, the user may easily and accurately imagine the following later part. That is, the user may imagine a note more accurately when listening to the first section 410 and then imagining the following second section 420 than when imagining the second section 420 without providing the first section 410. Therefore, in this case, the natural music imagination of the user may be induced, and the obtained EEG of the user may be considered to match a melody of the corresponding part at high accuracy As more natural imagination is induced, the stability of measured data (e.g., matching relationship between brain wave segments and pitch values) may be secured.

In an embodiment, for accuracy of measurement of the EEG data generated by the user imagining music, an operation of confirming what the imagined melody is to the user may be further performed after obtaining the EEG. In the confirmation operation of the imagined melody, the electronic device may allow a melody of the second section 420 imagined by the user in a music imagining operation to be humming, and determine whether the melody imagined by the user is identical to the second section 420 of previously known music.

FIGS. 5A and 5B are diagrams illustrating an operation in which an electronic device obtains a musical probability map according to a melodic progression probability according to an embodiment.

The electronic device according to an embodiment may analyze melodic progression information with respect to a plurality of pieces of previously known music. Tune or melody represents a set of notes arranged in a horizontal or temporal order in music. A pitch value pattern generally used in music may be known by analyzing the melodic progression information of the plurality of pieces of previously known music.

In an embodiment, a musical probability map may be calculated based on the musical elements of the plurality of pieces of previously known music. The musical probability map may include information related to a melodic probability that a specific pitch value is generated as a following note when considering at least one preceding scale. The melodic probability may be determined based on a frequency at which a specific pitch value is generated following a preceding scale in a plurality of pieces of previously known music.

For example, the musical probability map may include information about a transition probability of a pitch value in various pieces of previously known music. Using the transition probability information, a pitch value of a next note to appear in each note may be determined. The transition probability of the pitch value may indicate a probability of a melody progressing from a current note to a next note. For example, as a result of analyzing several pieces of previously known music, when a note having a pitch value of ‘Do (C)’ appears 10 times, and when ‘Mi’ (E) appears 3 times and ‘Sol (G)’ appears 7 times as a note after the note of ‘Do C’, the transition probability of a pitch value from ‘Do (C)’ to ‘Mi (E)’ may be 0.3, and the transition probability of a pitch value from ‘Do (C)’ to ‘Sol (G) may be 0.7. In an embodiment, the musical probability map may include transition probability information from two or more preceding note sequences to the next pitch value.

In an embodiment, two preceding notes may be considered to determine a pitch value of a specific note. That is, the musical probability map may include transition probability information from two or more preceding note sequences to the next pitch value. For example, referring to FIG. 5A, in a specific piece of previously known music, when two preceding notes are a sequence 510, 513, 515 of Sol (G)-Sol (G), ‘Fa (F)’ may be one time 511, ‘Sol (G)’ may be one time 514, and ‘Mi (E)’ may be one time 516 as the next note appearing in the corresponding sequence. A musical probability map generated from a piece of music shown in FIG. 5A may include information that each of ‘Mi (E)’, ‘Fa (F)’, and ‘Sol (G)’ has a probability of 33 % as pitch values of notes to generate after the sequence of Sol (G)-Sol (G), and other pitch values have a probability of 0 %.

In an embodiment, four preceding notes may be considered to determine the pitch value of a specific note. That is, the musical probability map may include transition probability information from four or more preceding note sequences to the next pitch value. For example, referring to FIG. 5B, in a specific piece of previously known music, when the four preceding notes have a sequence 520 of Sol (G)-Sol (G)-Fa (F)-X (rest), ‘Sol (G)’ may be one time as the next note appearing in the corresponding sequence. A musical probability map generated from a piece of music shown in FIG. 5B may include information that ‘Sol (G)’ has a probability of 100 % as the pitch value of a note to generate after the sequence of Sol (G)-Sol (G)-Fa (F)-X (rest), and other pitch values have a probability of 0 %.

Meanwhile, the number of preceding notes considered in the musical probability map is not limited to two or four mentioned above, and any number of preceding notes may be considered.

FIG. 6 is a diagram illustrating an operation in which an electronic device obtains a musical probability map according to a harmonic CM progression according to an embodiment.

The electronic device according to an embodiment may analyze harmonic progression information with respect to a plurality of pieces of previously known music. Harmony represents the temporal flow of sound generated by the succession of chords in music. A pitch value pattern generally used in music may be known by analyzing harmonic progression information with respect to the plurality of pieces of previously known music.

In an embodiment, a musical probability map may be calculated based on the musical elements of the plurality of pieces of previously known music. The musical probability map may include information related to a harmonic probability that a specific pitch value is generated as a following note when considering the harmony of music. For example, the harmonic probability may be determined based on the frequency at which the specific pitch value is generated based on harmonies, chords, and tones of a plurality of pieces of previously known music. For example, the musical probability map may include probability information that a specific pitch value is generated in a main melody in a specific harmony.

In an embodiment, in order to set the musical probability map according to the harmonic progression information, chords included in a specific piece of music may be limited to major three chords (first chord I, fourth chord IV, and fifth chord V) by applying a substitution chord rule to harmonies included in the plurality of pieces of previously known music.

Referring to FIG. 6, the musical probability map may include probability information indicating that each of pitch values C, D, E, F, G, A, B, rest appears in the specific harmony CM. For example, the musical probability map generated based on the music shown in FIG. 6 may include information indicating that each of ‘Do (C)’, ‘Re (D)’, and ‘Fa (F)’ has a probability of about 8 %, rest (X) has a probability of about 17%, ‘Mi (E)’ has a probability of about 25 %, ‘Sol (G)’ has a probability of about 33 %, and other pitch values have a probability of 0 % as pitch values of notes to be generated in the first chord I. In addition, the musical probability map generated based on the music shown in FIG. 6 may include information indicating that ‘Re (DC)’ has a probability of about 50 %, each of ‘Fa (F)’ and rest (X) has a probability of about 25 %, and other pitch values have a probability of 0 % as pitch values of notes to be generated in the fifth chord V.

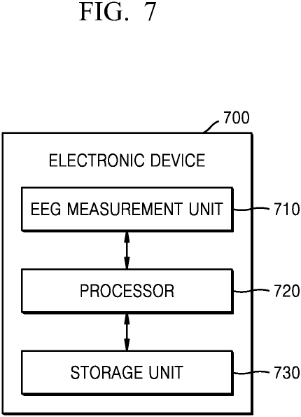

FIG. 7 is a block diagram of an electronic device 700 according to an embodiment.

The electronic device 700 may be a device that obtains an EEG by a user imagining music and outputs a melody matching the EEG. The electronic device 700 may be, for example, a smartphone, a tablet personal computer (PC), a mobile phone, a video phone, an e-book reader, a desktop PC, laptop PC, a netbook computer, a workstation, a server, a personal digital assistant (PDA), a portable multimedia player (PMP), an MP3 player, a mobile medical device, a camera, a wearable device, home appliances, or various computing devices. Meanwhile, the electronic device 700 according to an embodiment is not limited to the above examples, and the electronic device 700 may include various types of devices capable of matching a musical imaginary EEG with a melody.

Referring to FIG. 7, the electronic device 700 may include an EEG measurement unit 710, a processor 720, and a storage unit 730. All components shown in FIG. 7 are not indispensable components of the electronic device 700. The electronic device 700 may be implemented by components that are more or fewer than the components shown in FIG. 7.

The EEG measurement unit 710 may include a plurality of electrodes attached to the user’s scalp. The EEG measurement unit 710 may amplify fine electrical activity of the brain through the plurality of electrodes attached to the user’s scalp and record an EEG.

The storage unit 730 may store a program to be executed by the processor 720 to be described below to control the operation of the electronic device 700. The memory 930 may store a program including one or more instructions for controlling an operation of the electronic device 900. The memory 930 may store instructions and program codes, which are readable by the processor 920. In an embodiment, the processor 920 may be implemented to execute instructions or codes of the program stored in the memory 930. For example, the memory 930 may store data input to or output from the electronic device 900.

The memory 9300 may include, for example, a storage medium of at least one type of a flash memory type, a hard disk type, a multimedia card micro type, a card type memory (e.g., a secure digital (SD) or extreme digital (XD) memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. However, the memory 930 is not limited to the above-described example, and may include any type of storage medium in which data may be stored.

Programs stored in the storage unit 730 may be classified into a plurality of modules according to their functions. For example, programs stored in the storage unit 730 may be classified into a music sample providing module, a measurement data storage module, a model learning module, a music creation intention recognition module, etc. according to their functions. The music sample providing module may include a music database and a music sound generating module. The model learning module may perform functions such as a preprocessing operation, a key point extraction operation, a classification operation, etc.

The music sample providing module may provide a user with at least part of a previously known piece of music in order to induce the natural music imagination of the user in an operation of generating a statistical probability map including matching probability information between brain wave segments and pitch values.

The processor 720 may control overall operations of the electronic device 700. For example, the processor 720 may generally control the EEG measurement unit 710 and the storage unit 730 by executing programs stored in the storage unit 730.

The processor 720 may include hardware components that perform arithmetic, logic and input/output operations and signal processing. The processor 720 may include at least one of, for example, a central processing unit, a microprocessor, a graphic processing unit, application specific integrated circuits (ASICs), digital signal processors (DSPs), digital signal processing devices (DSPDs), programmable logic devices (PLDs), and field programmable gate arrays (FPGAs) but is not limited thereto.

The processor 720 may match the musical imaginary EEG with the melody by executing the one or more instructions stored in the storage unit 730. For example, the processor 720 may obtain an EEG generated by a user imagining music through the EEG measurement unit 710, obtain at least one brain wave segment from the EEG, identify key points included in the brain wave segments, matches a pitch value to each of the brain wave segments based on the identified key points, and compensate for the pitch value matching the brain wave segment based on the musical probability map, by executing the one or more instructions stored in the storage unit 730. The musical probability map may be stored in the storage unit 730.

An operation in which the processor 720 obtains the EEG generated by the user imagining music through the EEG measurement unit 710 may correspond to part of operation 120 of FIG. 1 or operation 210 of FIG. 2 described above. An operation in which the processor 720 obtains the at least one brain wave segment from the obtained EEG may correspond to part of operation 120 of FIG. 1 or operation 220 of FIG. 2 described above. An operation in which the processor 720 identifies the key points included in the brain wave segment may correspond to part of operation 120 of FIG. 1 or part of operation 230 of FIG. 2 described above. An operation in which the processor 720 matches the pitch value to each of the brain wave segments based on the identified key points may correspond to part of operation 130 of FIG. 1 or part of operation 230 of FIG. 2 described above. An operation in which the processor 720 compensates for the pitch value matching the brain wave segment based on the musical probability map may correspond to part of operation 130 of FIG. 1 or operation 240 of FIG. 2 described above.

As described above, according to an embodiment, the musical imaginary EEG obtained from the user may match the melody closer to the intention of the user, by matching a brain wave segment with a pitch value based on a musical probability map considering at least one pitch value as well as a statistical pitch value classification probability based on key points of the brain wave segment.

In addition, according to an embodiment, pitch values classified based on key points of brain wave segments may be compensated for based on the musical probability map representing the probability of appearance of a training pitch value according to the melodic progression and harmony, thereby converting the EEG 121 generated from the music imagination into a more natural melody, and assisting a non-professional in music creation through music imagination.

Various embodiments of the disclosure may be implemented or supported by one or more computer programs, and computer programs may be formed from computer-readable program code and recorded in computer-readable media. In the disclosure, an “application” and a “program” indicate one or more computer programs, software components, instruction sets, a procedure, a function, an object, a class an instance, related data, or a part thereof, which are suitable for implementation in computer-readable program code. The “computer-readable program code” may include various types of computer code including source code, purpose code, and executable code. The “computer-readable media” may include various types of media accessible by computers, such as ROM, RAM, hard disk drive (HDD), compact disc (CD), digital video disc (DVD), or various types of memory.

A machine-readable storage medium may be provided in the form of a non-transitory storage medium. Here, a ‘non-transitory storage medium’ is a tangible device and may exclude wired, wireless, optical, or other communication links that transmit temporary electrical or other signals. Meanwhile, the ‘non-transitory storage medium’ may not distinguish a case where data is stored semi-permanently in the storage medium from a case where data is temporarily stored in the storage medium. For example, the ‘non-transitory storage medium’ may include a buffer in which data is temporarily stored. A computer-readable recording medium may be an available medium that is accessible by a computer, and includes all of a volatile medium, a non-volatile medium, a separated medium, and a non-separated medium. Computer-readable media may include media in which data may be permanently stored and media on which data may be later overwritten after stored, such as rewritable optical disks or erasable memory devices.

According to an embodiment, a method according to various embodiments of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be electronically distributed (e.g., downloaded or uploaded) via an application store or directly between two user devices (e.g., smartphones). When distributed online, at least a part of the computer program product (e.g., a downloadable app) may be at least temporarily stored or temporarily generated in the machine-readable storage medium, such as memory of the manufacturer’s server, a server of the application store, or a relay server.

Those of ordinary skill in the art to which the disclosure pertains will appreciate that the disclosure may be implemented in different detailed ways without departing from the technical spirit or essential characteristics of the disclosure. Accordingly, the aforementioned embodiments of the disclosure should be construed as being only illustrative, but should not be constructed as being restrictive from all aspects. For example, each element described as a single type may be implemented in a distributed manner, and likewise, elements described as being distributed may be implemented as a coupled type.

The scope of the disclosure is defined by the following claims rather than the detailed description, and the meanings and scope of the claims and all changes or modified forms derived from their equivalents should be construed as falling within the scope of the disclosure.

According to the method and electronic device for matching a musical imaginary EEG with a melody proposed in the disclosure, an EEG based on a musical probability map considering harmony or at least one preceding pitch value as well as a pitch value classification probability according to key points of a brain wave segment. By matching the segment and the pitch value, the imagined music EEG obtained from the user may be matching a melody closer to the user’s imagined intention.

In addition, according to the method and electronic device for matching the musical imaginary EEG with the melody proposed in the disclosure, the pitch value classified based on the key point of the brain wave segment is converted into a musical sound value indicating the probability of occurrence of a following pitch value according to the progression of a harmony or melody. By compensating based on the probability map, it is possible to convert the EEG by music imagination into a more natural melody, and it is possible to assist non-experts in music creation through music imagination.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method, performed by an electronic device, of matching a musical imaginary electroencephalogram (EEG) with a melody, the method comprising:
obtaining an EEG generated by imagining music from a user;
obtaining at least one brain wave segment from the EEG;
identifying key points included in the at least one brain wave segment;
matching a pitch value to each of the at least one brain wave segment based on the identified key points; and
compensating for the pitch value matching the at least one brain wave segment based on a musical probability map.

2. The method of claim 1, wherein the obtaining of the EEG generated by imagining music from the user includes a preprocessing operation of removing noise unrelated to music imagination from the EEG obtained from the user.

3. The method of claim 1, wherein the obtaining of the at least one brain wave segment from the EEG includes dividing the EEG into at least one brain wave segment based on a preset rhythm.

4. The method of claim 1, wherein the identifying of the key points included in the at least one brain wave segment includes identifying the key points included in the at least one brain wave segment based on an F value of the at least one brain wave segment.

5. The method of claim 1, wherein the matching of the pitch value to each of the at least one brain wave segment based on the identified key points includes matching the pitch value to each of the at least one brain wave segment based on a statistical probability map determined according to a correspondence between a key point set included in a specific brain wave segment and the pitch value.

6. The method of claim 5, wherein the compensating for of the pitch value matching the at least one brain wave segment based on the musical probability map includes determining a pitch value corresponding to the at least one brain wave segment according to the statistical probability map and the musical probability map through a Bayesian model.

7. The method of claim 5, wherein the statistical probability map is trained based on an EEG obtained as a user is provided with part of preset music and imagines part of the music following the provided part of the music.

8. The method of claim 1, wherein the musical probability map is determined based on a melodic progression of a plurality of pieces of preset music.

9. The method of claim 8, wherein the musical probability map includes probability information of occurrence of a following pitch value with respect to two preceding pitch value sets or probability information of occurrence of a following pitch value with respect to four preceding pitch value sets.

10. The method of claim 1, wherein the musical probability map is determined based on a harmonic progression of a plurality of pieces of preset music.

11. The method of claim 1, wherein the method is identified in a plurality of modes according to a degree of compensation for the pitch value matching the at least one brain wave segment based on the musical probability map.

12. An electronic device matching musical imaginary electroencephalogram (EEG) with a melody, the electronic device comprising:
an EEG measurement unit;
a storage unit storing one or more instructions; and
at least one processor configured to execute the one or more instructions stored in the memory, to:
obtain an EEG generated by a user imagining music through the EEG measurement unit;
obtain at least one brain wave segment from the EEG;
identify key points included in the at least one brain wave segment;
match a pitch value to each of the at least one brain wave segment based on the identified key points; and
compensate for the pitch value matching the at least one brain wave segment based on a musical probability map stored in the storage unit.

13. A non-transitory recording medium having recorded thereon a program for executing the method of claim 1 on a computer.
